(19) United States
(12) Patent Application Publication
(10) Pub. No.: US 2024/0170978 A1
(43) Pub. Date: May 23, 2024

(54) Smart Battery Switch for Automatic Charging and Equalization During Off-Mode

(71) Applicant: Kannappan Karuppan Chettiar, Gilroy, CA (US)

(72) Inventor: Kannappan Karuppan Chettiar, Gilroy, CA (US)

(21) Appl. No.: 18/515,855

(22) Filed: Nov. 21, 2023

Related U.S. Application Data
(60) Provisional application No. 63/427,807, filed on Nov. 23, 2022.

(51) Int. Cl. H02J 7/00; H02J 7/35

(52) U.S. Cl. CPC H02J 7/0024; H02J 7/0048; H02J 7/0063; H02J 7/007186; H02J 7/35; H02J 2300/24

(57) ABSTRACT

An innovative smart battery switch enhances the affordability and reliability of sustainable energy. The core of this system is a smart switch capable of alternating between series and parallel modes. In the parallel off-mode, it automatically enables battery charging and cell equalization, thereby replacing complex and expensive battery management systems. This feature, coupled with the system's low voltage charging capability, significantly extends battery lifespan by minimizing cell stress. The integrated kinematic charger optimizes solar photovoltaic (PV) energy utilization, adapting efficiently to varying solar conditions. This charger not only improves solar energy conversion efficiency but also reduces the solar panel size requirement, making sustainable energy solutions more accessible. The system's adaptability, including variable voltage outputs and IoT compatibility, extends its applications to a range of devices, from LED lighting to electric vehicles, offering a cost-effective, sustainable approach to energy management.

### CROSS-REFERENCE TO RELATED APPLICATION

The present patent application claims benefit and priority to U.S. Provisional Patent Application No. 63/427,807 entitled “Method to Improve Battery Performance with Battery Balancing Switch” filed on Nov. 23, 2022 which is hereby incorporated by reference into the present disclosure.

### FIELD OF THE INVENTION

The invention is a smart battery switch for series-stacked battery systems that enables kinematic or spatial voltage transitions from a low voltage source to a higher voltage load, incorporates parallel cell balancing and charging during redundancy, and provides series output voltage to the load using an isolated load charging method, all while integrating uninterruptedly with fluctuating renewable energy sources.

### BACKGROUND OF THE INVENTION

Batteries play a pivotal role in various applications, from portable electronic devices to electric vehicles and renewable energy storage systems. Traditional battery systems have fixed single voltage configurations which are over-designed. In many cases, batteries are fixed in series, for both charging and discharging, to achieve the desired higher voltage levels, making them well-suited for specific applications.

However, series-connected batteries present several challenges, primarily related to battery management and equalization. When batteries are connected in series, they can experience voltage imbalances due to variations in individual cell characteristics, aging, or temperature differences during operation. These voltage imbalances can result in reduced battery life, diminished capacity, and suboptimal performance.

FIGS. 1A and 1B illustrate the problem caused by unbalanced batteries during charging and discharging states respectively.

In prior art battery balancing methods like active and passive approaches maintain voltage levels and equalize cell state of charge (SOC) or battery balancing or cell balancing. This enhances battery performance and lifespan by preventing overcharging or over-discharging. Passive methods redistribute charge using resistors, capacitors, or diodes, while active methods use circuits with switches for active charge transfer. Active balancing is complex and costly, and various variations exist to match battery types and system requirements.

Electrical switches are devices that promote conservation by effectively deactivating batteries that would otherwise remain continuously active, leading to wastage and heightened expenses for consumers. Moreover, these batteries necessitate recharging and have predetermined charge and discharge cycles based on their unique battery chemistry, underlining the significance of battery conservation through switch usage.

Battery systems equipped with electrical switches face a critical safety challenge: they often struggle to simultaneously handle both battery charging and discharging functions within the same system. This limitation stems from the essential requirement to maintain a strict separation between the charging and discharging processes. Attempting to charge and discharge batteries concurrently can pose significant safety risks, including the potential for overcharging, over-discharging, and excessive heat generation. These risks are particularly pronounced when employing high-speed, high-voltage fast charging methods. Such hazards can lead to reduced battery lifespan, potential damage, and even safety incidents such as thermal runaway. To address these significant safety concerns, battery management systems incorporate specialized circuitry and switches. These components ensure that the charging and discharging processes occur sequentially and with the necessary isolation, thereby safeguarding both the integrity of the battery system and the safety of users and equipment.

FIG. 2 represents prior art illustrating the use of electrical switches to alternate between the load and the battery, resulting in competition for power source access. Notably, when using batteries, a renewable power source is either capable of discharging to the load or charging from the renewable energy source at any particular time.

Voltage (V) and current (A) in photovoltaic (PV) energy generation function in distinct and critical roles that together facilitate the transformation of sunlight into usable electrical energy. Voltage, a critical component, is necessary for driving the movement of electrons within the system. It acts as the driving force or “push” that initiates the electron flow but does not directly translate into the actual work or useful energy output. Essentially, voltage provides the potential energy that sets the stage for electrical flow, but by itself, it does not perform the work.

In contrast, current refers to the actual flow of electrons through the conductor, representing the kinetic energy of the system. Unlike voltage, which establishes the potential for work, current is directly tied to the amount of energy that is being delivered to perform work, such as powering a device or meeting a specific load requirement. It is the flow of electrons, driven by the “push” provided by voltage, that determines the quantity of useful energy.

Typical PV solar systems are designed with fixed parameters. For instance, to charge a 12V load, the solar panel systems must produce voltages higher than 12V. They are often configured to operate around 18V to handle the variable solar irradiance that the PV system receives. To manage this variability and protect against potential overvoltage, solar charge controllers are used. These controllers employ a PWM (Pulse Width Modulation) or MPPT (Maximum Power Point Tracking) method to modulate the amount of energy from the sun's irradiance reaching the load. This is crucial because the load might not be equipped to handle excessive voltages, especially as 18V solar panels can peak at approximately 30V during periods of high irradiance. Essentially, these controllers act like a curtain, regulating the sun's energy to indirectly control the voltage generated by the solar panel. During periods of low irradiance, the voltage may be insufficient, preventing the solar PV system from charging the load. Solar charge controllers, including PWM and MPPT controllers, modulate solar energy and indirectly control solar panel-generated voltage, safeguarding devices. These controllers prevent voltage issues and ensure efficient PV system operation, even during low irradiance.

A notable historical innovation in the development of electrical switches is the “quick break mechanism” pioneered by John Henry Holmes in 1884. This ingenious mechanism revolutionized the field by significantly reducing the time required to establish or interrupt an electrical circuit. By minimizing the duration of electrical arcing upon switch operation, Holmes' invention not only enhanced safety but also extended the operational lifespan of switches. While electrical arcing is more prevalent in AC systems due to voltage reversals, Holmes' quick break mechanism continues to be relevant and cost-effective, finding its application in various types of switches employed worldwide.

FIG. 3 is a prior art ‘make or break’ switch invented by Holmes.

Over the course of technological progress, the fundamental workings of switches have remained relatively unchanged. While advancements have undoubtedly made switches more reliable and efficient, the core mechanism continues to operate on a simple principle-a one-way switch, which essentially serves as a ‘make or break’ device. When switched on, it establishes a connection between two terminals, and when switched off, it severs that connection. By combining two one-way switches, one can create a two-way switch, allowing for the connection of one terminal at a time while breaking the connection with the other. This evolution in switch design has shaped the landscape of switchboards over the years, with the primary distinction being the transition from one-way to two-way switches.

The prior art, as described in U.S. Pat. No. 11,398,735B2 by the same inventor, outlines dynamic electronic battery connections that utilize time-modulated parallel and series switching to achieve an average voltage controlled by a microcontroller unit, combined with high-speed transistor switching. However, it is important to note that high-speed switching may not be suitable for human health and lifestyle considerations, and microcontrollers can also involve more complex software algorithms and pose cost challenges for economically disadvantaged nations, which should be taken into account in climate action solutions as affordability is a pre-requisite for inclusive action towards resolving climate change.

In essence, today's switches can trace their lineage back to the foundational concepts pioneered by John Henry Holmes. However, it is noteworthy that the Holmes method, while effective in its time, had certain limitations—chiefly, it tended to fix the configuration of battery systems. For example, during the on mode, a battery system employing the Holmes method would remain fixed as an N-battery fixed series configuration. Switching to lower battery configuration such as N-1 was not possible, necessitating the physical disconnection and reconfiguration of the battery setup. This limitation hindered adaptability and flexibility of the ubiquitous on-off switches especially when deployed in battery systems.

### SUMMARY OF THE INVENTION

The smart battery switch invention enables affordable kinematic or spatial voltage transitions in battery systems, shifting between N-battery series voltage, lowering incrementally in series from N-1, N-2 until achieving the lowest voltage in N-battery parallel modes without physical disconnections. It also facilitates efficient low voltage parallel charging during off-mode and provides series voltage for load power using an isolated load charging method ensuring battery safety and longevity.

The invention introduces an uninterruptible renewable system, using parallel and series isolated load shifting, that further enables the shifting of solar Watt-Peak to battery Watt-Peak, achieved through a dual-voltage setup with a lower parallel voltage for charging and a higher series voltage for discharging. This flexibility is crucial for space-limited applications, such as electric vehicles.

The innovation seeks to streamline battery management by placing the battery as the “central bank”, enhancing renewable energy efficiency by incorporating PWM/MPPT algorithms within battery systems instead of placing them externally like other PWM/MPPT solar charge controllers, improving the overall performance of series-connected batteries, and reducing the carbon footprint by minimizing the number of components involved in balancing series-connected battery systems.

### BRIEF DESCRIPTION OF THE DRAWINGS

FIG. 1A illustrates problem faced by series-connected batteries during charging.

FIG. 1B illustrates problem faced by series-connected batteries during discharging.

FIG. 2 is a prior art switch system illustration where the battery competes with the load.

FIG. 3 is a prior art ‘make or break’ switch invented by Holmes.

FIG. 4A illustrates switch used to isolate parallel and series circuits for 2-battery system.

FIG. 4B illustrates switch used to isolate parallel and series circuits for 4-battery system.

FIG. 5 illustrates the battery equalization process using the parallel-phase.

FIG. 6 is a graph illustrating intermittent discharge in series battery system.

FIG. 7 is a graph illustrating intermittent switching to parallel in series battery system.

FIG. 8 illustrates an isolated load charging in parallel off-state using PIR sensor.

FIG. 9 illustrates a 3-state switching where parallel is used for low voltage.

FIG. 10A illustrates 3-mode switch for 4-battery system.

FIG. 10B illustrates 3-mode switch for 2-battery system.

FIG. 11A illustrates a 3-mode switch on on-mode.

FIG. 11B illustrates a 3-mode switch on off-mode.

FIG. 11C illustrates a 3-mode switch on charging mode.

FIG. 12A illustrates on-mode with 3-batteries in series.

FIG. 12B illustrates on-mode with 2-batteries in series.

FIG. 12C illustrates off-mode with 3 batteries in parallel.

FIG. 12D illustrates charging mode with 3 batteries in parallel.

FIG. 13 illustrates a 4-gear mode system for BEV with B-balancing mode.

FIG. 14 illustrates the battery as a “central bank” in energy systems.

FIG. 15 illustrates that source voltage may be lower than load voltage.

FIG. 16 illustrates the Kinematic Charger matches the current for the load.

FIG. 17 illustrates an experimental comparison of two solar panel systems of 60 W with different voltage and current.

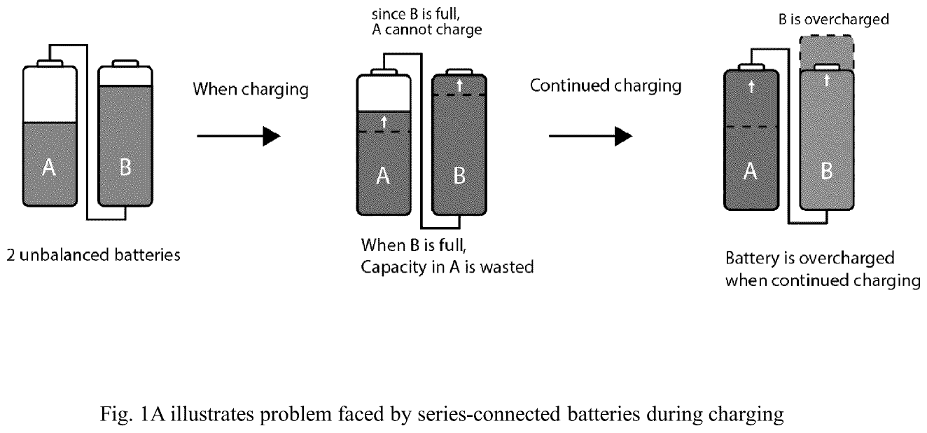

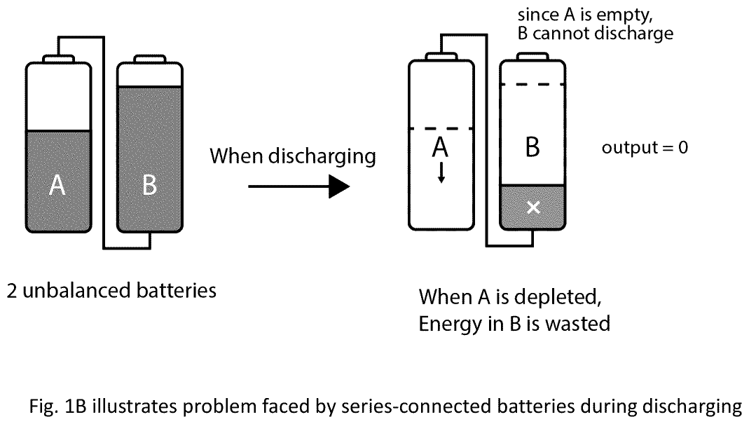

### DETAILED DESCRIPTION OF THE INVENTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Departing from Traditional ‘Make or Break’ Switch Systems

A battery stores potential energy in its chemical composition and structure, which is converted into electrical energy when connected to a circuit. The standard on-off switch, commonly found in homes and offices, is a simple mechanism intended to interrupt a single circuit, thereby conserving energy when the connected device is not in use. This functionality can be realized using a basic toggle switch called the double-pole double-throw (DPDT), or through electromechanical devices like relays, or even electronic switches employing transistors which are space-based without timer controls or the use of microcontrollers.

Electrical systems employing alternating current (AC) and direct current (DC) necessitate distinct types of switches tailored to their unique characteristics. However, in current practice, conventional ‘make or break’ switches are ubiquitously utilized across both AC and DC circuits, including battery applications. Existing prior art flip-switches used in series-connected battery systems have limitations as they completely disconnect the batteries. A more efficient approach involves rearranging the batteries into a parallel circuit during rest periods when the load is not required. This allows the batteries to remain connected in a parallel configuration, ready for use while conserving energy by disconnecting the load without manual physical termination.

In the context of most battery systems, connections are typically established in a series configuration, effectively rendering the operation of ‘make and break’ switches as fixed series-mode switches during the ‘make’ phase, subsequently severed during the ‘break’ phase.

An innovative approach involves the transformation of the switch's functionality to facilitate series-mode operation during the ‘make’ or on-mode. However, during the ‘break’ or off-mode, the switch kinematically transitions into a parallel configuration, effectively establishing an off-mode during the redundancy state that inherently becomes a parallel mode that may also be disconnected from the load. This reconfiguration enables the same set of batteries within the system to be harnessed as parallel circuits, thus optimizing their utility within the battery system.

The invention introduces the Active Zero switch, a unique on-off switch inspired by gear modes in cars. The switch represents “0” (“Zero) as “Active”, indicating a neutral resting state. Unlike traditional switches, the Active Zero switch improves battery performance by enabling battery or cell balancing during idle periods by connecting the same batteries in parallel while disconnecting them from the load, eliminating the need for manual disconnection or switching. During the “off” mode, the switch automatically establishes a parallel connection among the batteries, promoting automatic balancing and equalization of the cells. This addresses imbalances in series-connected battery configurations and enhances overall battery performance when discharging after a period of rest. In the “on” mode, the switch optimizes power output by connecting the batteries in series.

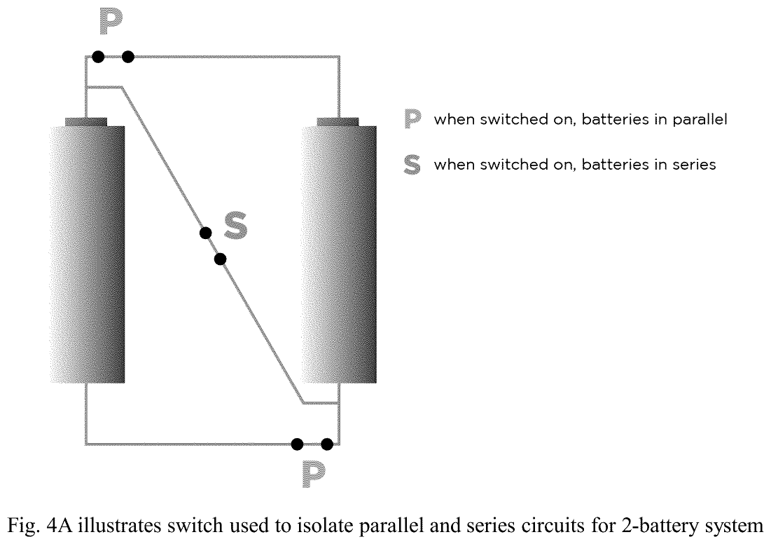

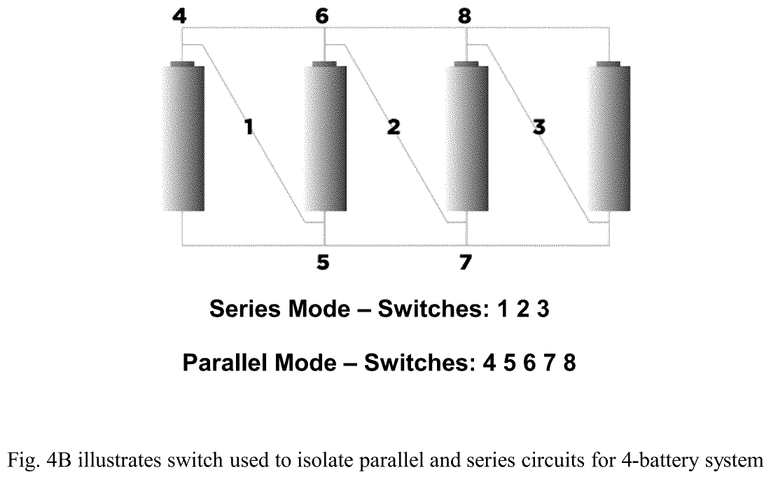

FIGS. 4A and 4B depict exemplary embodiments of a 2-battery and 4-battery system respectively, each equipped with a battery balancing Active Zero flip-switch. This smart battery switch comprises two isolated circuits: one for series operation and the other for parallel operation. The flip-switch toggles between the series circuit in the on mode and the parallel circuit in the off mode to facilitate battery balancing. The key advantage of this innovative switch is its ability to separate the charging cycle from the discharging cycle enabling a load isolated charging system. This is achieved by allowing the battery system to connect to the power source exclusively during the off-mode when the system is disconnected from the load, ensuring complete isolation of the charging and discharging processes.

Parallel circuit for batteries is similar to a rest state for energy storage systems that enables all the batteries to be equalized when the series-connected batteries are subsequently turned to the on-mode for discharge as the voltage imbalance will be reduced.

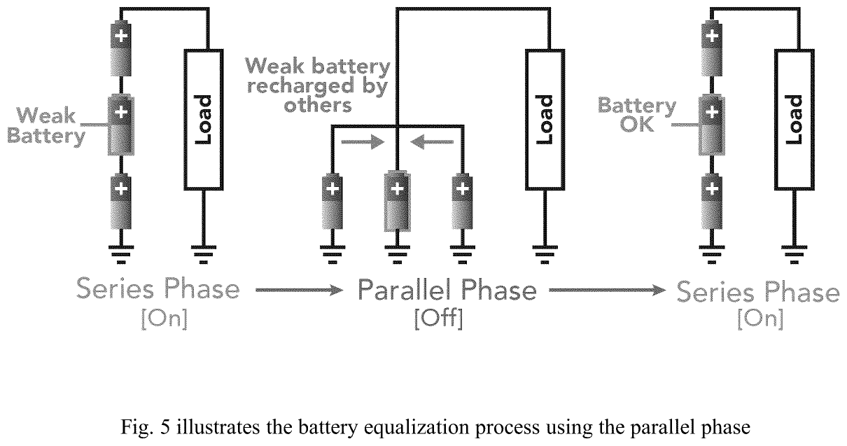

FIG. 5 illustrates the battery equalization process when series-connected batteries are switched intermittently to the parallel-state.

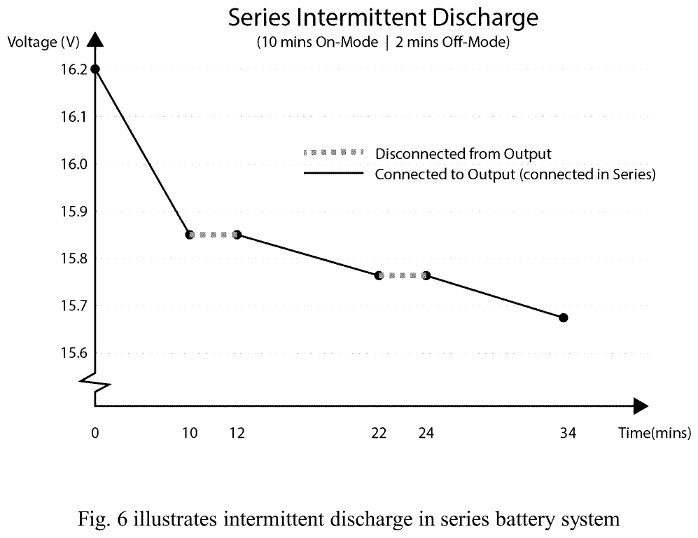

Table 1 presents experimental data comparing voltage levels across four batteries during a 10-minute discharge in series, followed by a 2-minute off period. FIG. 6 illustrates the resulting state of charge in a typical series-connected battery system.

TABLE 1
Series Intermittent Circuit

| | Time | | Battery Voltage | | | | Output |
|---|---|---|---|---|---|---|---|
| Step | (m) | Mode | A | B | C | D | Voltage |
| 1 | 0 | Standby | 4.05 | 4.05 | 4.05 | 4.05 | 16.20 |
| 2 | 10 | On-Series | 4.03 | 4.01 | 4.01 | 4.02 | 15.85 |
| 3 | 12 | Off-Disconnect | 4.04 | 4.02 | 4.02 | 4.03 | NA |
| 4 | 22 | On-Series | 4.02 | 3.98 | 3.99 | 4.01 | 15.77 |
| 5 | 24 | Off-Disconnect | 3.98 | 3.96 | 3.97 | 3.98 | NA |
| 6 | 34 | On-Series | 3.99 | 3.97 | 3.98 | 3.99 | 15.68 |

TABLE 2
Parallel-Series Intermittent Circuit

| | Time | | Battery Voltage | | | | Output |
|---|---|---|---|---|---|---|---|
| Step | (m) | Mode | A | B | C | D | Voltage |
| 1 | 0 | Standby | 4.02 | 4.02 | 4.02 | 4.02 | 16.08 |
| 2 | 10 | On-Series | 3.94 | 3.95 | 3.80 | 3.95 | 15.17 |
| 3 | 12 | Off-Parallel | 4.00 | 4.00 | 4.00 | 4.00 | NA |
| 4 | 22 | On-Series | 3.92 | 3.93 | 3.81 | 3.94 | 15.20 |
| 5 | 24 | Off-Parallel | 3.98 | 3.96 | 3.97 | 3.98 | NA |
| 6 | 34 | On-Series | 3.91 | 3.90 | 3.80 | 3.91 | 15.27 |

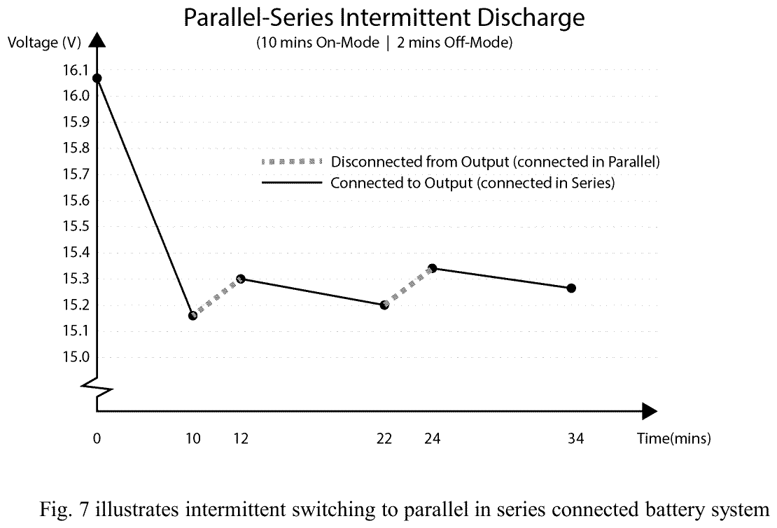

Table 2 presents comparative results for the same four batteries, involving a 10-minute series discharge followed by a switch to parallel connection for the subsequent 2-minute interval. FIG. 7 illustrates the operation of the kinematic smart battery switch. Notably, a voltage improvement is observed in Table 2 when the battery system switches to parallel mode, compared to complete disconnection in series (Table 1) which shows only a drop in voltage, where the voltage in Table 2 improves to 15.27V in step 6 compared to 15.20V in step 4 and 15.17 in step 2. Additionally, typical series-connected batteries would exhibit lower voltage after being connected to the load, but in this case, a marginal voltage increase is noticeable after just a 2-minute interval in parallel mode, further enhancing the series-connected voltage for the next cycle.

The smart battery switch enhances the voltage of series-connected batteries by equalizing their state of charge during the parallel state resulting in a longer battery lifespan as it periodically shifts to parallel mode for cell balancing. This highlights the practicality of the smart battery switch's ability to transition kinematically between series and parallel states, emphasizing the advantages of the new on-off switch for toggling between these configurations. The process differs from conventional battery or cell balancing methods where the battery with the highest voltage loses energy to the lowest voltage battery. In this new method, the battery with the lowest voltage receives marginal energy externally, such as from a solar source, allowing the highest voltage battery to retain its energy without any losses. Additionally, it enables the weakest cells to improve their charge, leading to overall enhancement of the entire battery pack.

FIG. 8 presents an exemplary embodiment of a load-isolated charging system featuring an on-off switch. This system, powered by 6V renewable energy such as solar, is adept at charging 4V battery systems and can discharge at 12V to operate a universal LED light equipped with a PIR (passive infrared) sensor, from to its configuration of three batteries in series. When switched on, it connects to this series arrangement of batteries to discharge the batteries to the load, whereas in the off-mode, it shifts to a parallel configuration for cell balancing and disconnects from the load to enable the charging of the battery system.

Renewable energy sources, such as solar, are inherently intermittent or constantly fluctuating, with factors like cloud cover, dust, and smoke impacting solar irradiance. This intermittency mirrors the behavior of all electrical loads which also exhibit intermittent usage patterns, necessitating disconnection periods or rest. These resting states provide an ideal opportunity for recharging batteries using a switch mechanism.

This concept is especially beneficial for LED lighting systems, which are efficient but typically operate on DC power while being connected to AC grids. This mismatch results in conversion losses of up to 30% when converting AC to DC. By directly charging the LED system from a battery connected to a renewable source, significant energy savings are realized, given that both LED lights and renewable systems inherently operate on DC power.

Further enhancing these savings, the integration of a Passive Infrared Sensor (PIR) into the LED lighting system can significantly reduce energy waste commonly caused by lights being left on. This system, compatible with Internet of Things (IOT) devices, increases efficiency by automatically controlling lighting based on occupancy.

To address the inefficiencies found in typical renewable energy setups, where inverters convert DC to AC, resulting in 20-60% energy losses (with the higher loss resulting from overdesigned systems), and subsequently reconverted into DC, a kinematic or space-based switch system proves more efficient. Such a system, suitable for both homes and businesses, minimizes energy loss by charging batteries during off periods and avoiding unnecessary energy conversions. This not only provides a cost-effective energy solution but also promotes energy conservation by utilizing the inherent DC nature of both LED lights and renewable energy sources.

Smart Switch with Twin Output Voltage Modes

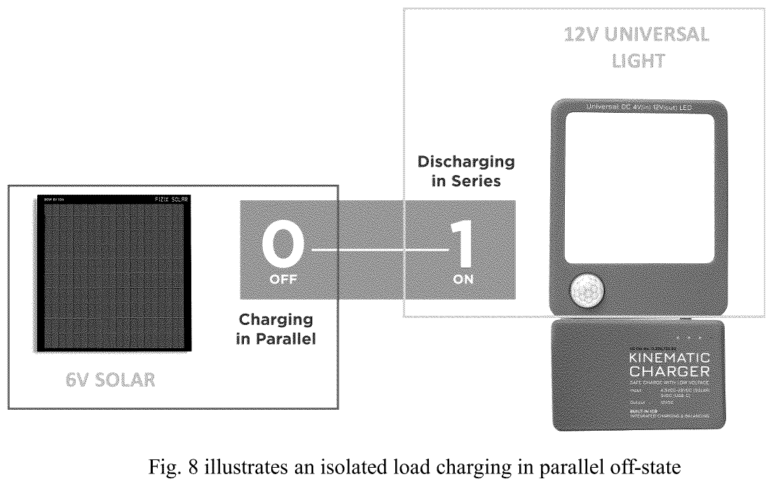

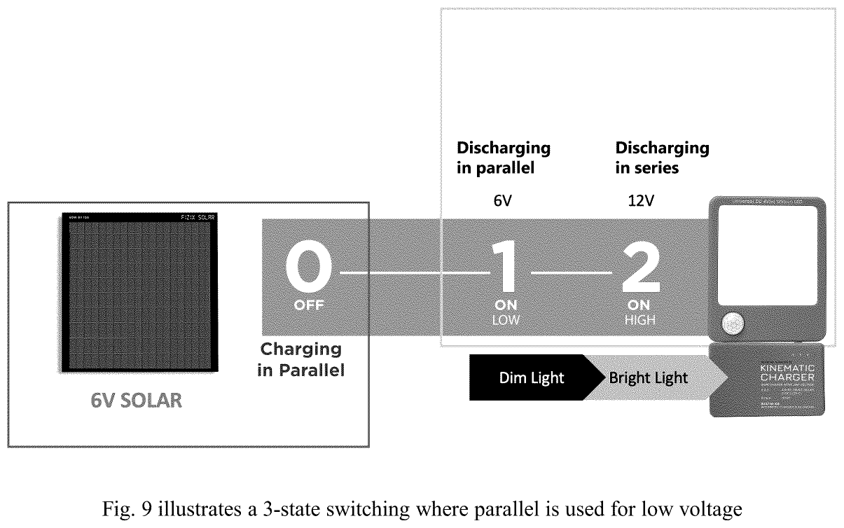

FIG. 9 introduces an alternative scenario to FIG. 8, demonstrating how the previously mentioned 3-battery system can be connected to the load to provide a lower voltage option where the 3-battery system is configured to parallel mode. This parallel circuit configuration of the battery system does not combine the voltages but extends the duration, promoting energy conservation. This application is particularly valuable in military operations, especially for LED flashlights used by soldiers during nighttime exercises under low-light conditions. Unlike conventional flashlights with fixed battery life and brightness levels, this approach offers adaptability. It ensures that soldiers can remain inconspicuous to the enemy while also delivering bright illumination when required. In contrast to existing LED flashlights that rely on complex systems such as resistive, TRIAC, or PWM switching methods, this solution provides a simpler and more energy-efficient alternative. It eliminates the need for filters, which typically result in energy waste in traditional flashlight designs.

In the realm of the Internet of Things (IOT), the application of a smart switch with dual output voltage modes holds significant promise. It seamlessly integrates with various IoT devices, including security cameras, to optimize their power management. These IoT devices often operate in a low-power state to conserve energy during idle periods. For instance, security cameras can remain in a low-power standby mode, consuming minimal power, while constantly monitoring their surroundings. When triggered by specific events such as motion detection or scheduled surveillance tasks, these devices can swiftly transition to their higher-powered operational states. This intelligent power management approach ensures efficient surveillance and monitoring while minimizing energy consumption during periods of inactivity.

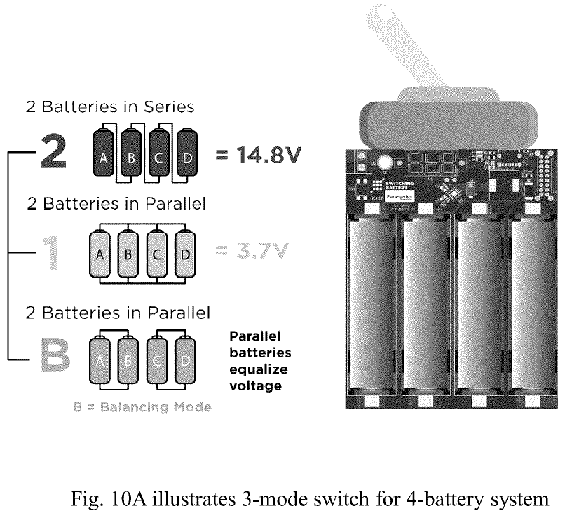

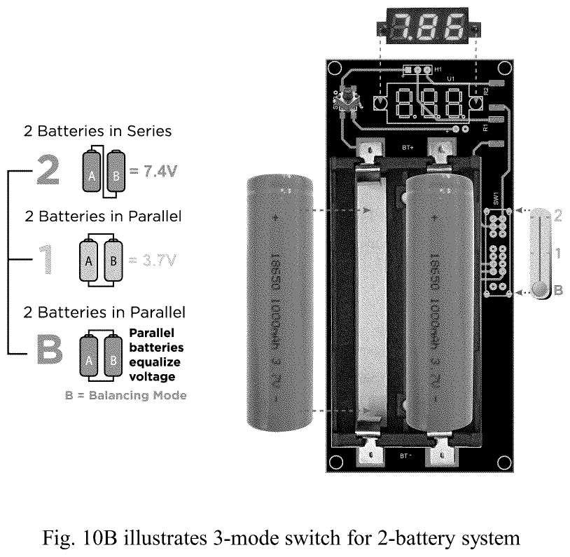

FIG. 10A illustrates a typical embodiment of a 4V, 4-battery system using PCB featuring three operating modes of the smart switch: on-mode in series voltage of 16V, on-mode in parallel voltage of 4V, and off-mode in parallel. During the off-mode, the batteries are isolated from the load. In contrast, the on-mode in series connects the batteries in series, as depicted in this example with a 4-battery configuration. This series configuration can scale to accommodate any number of series-connected batteries, providing a high voltage mode. Conversely, the on-mode in parallel represents a low voltage mode, as it connects the batteries in parallel.

FIG. 10B illustrates a typical embodiment similar to FIG. 10A but featuring a 2-battery system.

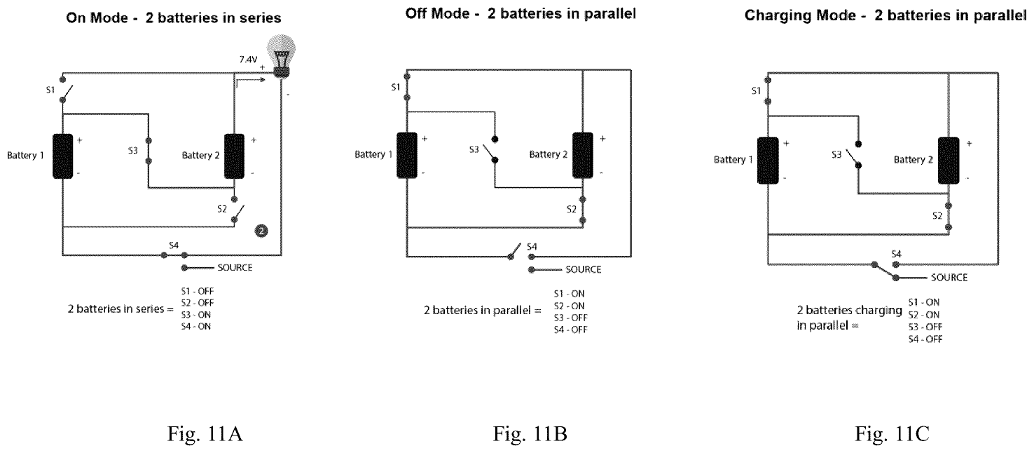

FIGS. 11A, 11B and 11C is an exemplary 2-battery embodiment that has a 3-mode switch incorporated as on-mode in series, off-mode in parallel and charging mode in parallel respectively. During the on-mode, it is configured in series circuits and during the off-mode, the batteries are reconfigured in parallel circuits which may alternately also be connected to a charging mode to enable charging.

Smart Switch with Multiple ‘Gear’ Modes

The smart switch system for batteries extends battery life by reducing voltage for dimming instead of using filters and lens in a typical flashlight system where the extra energy drawn is wasted and can be conserved using the smart battery switch.

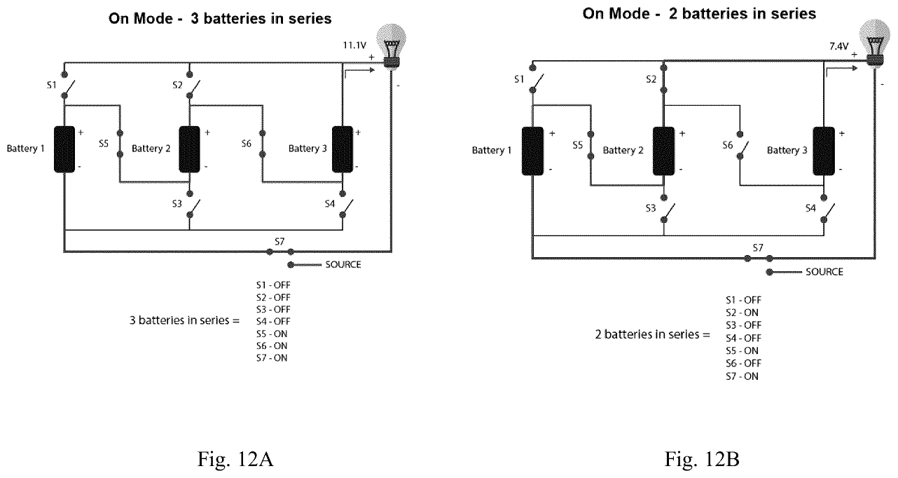

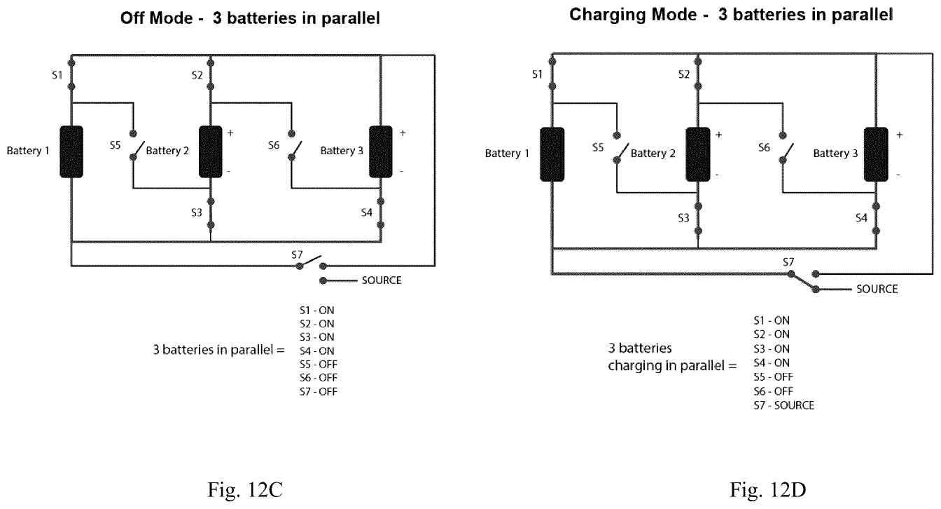

FIG. 12, while similar to FIG. 11, is specifically designed for a 3-battery system rather than a 2-battery setup. FIG. 12A is an exemplary embodiment of a 3-battery system arranged in series during the on-mode. This mode features two low-power options: one with the combined voltage of all three batteries, as depicted in FIG. 12A, and the other with a series connection of two batteries, as illustrated in FIG. 12B. FIG. 12C demonstrates the system configuration when it's in the off-mode. Lastly, FIG. 12D presents the charging mode, which is particularly effective in applications akin to a gear system.

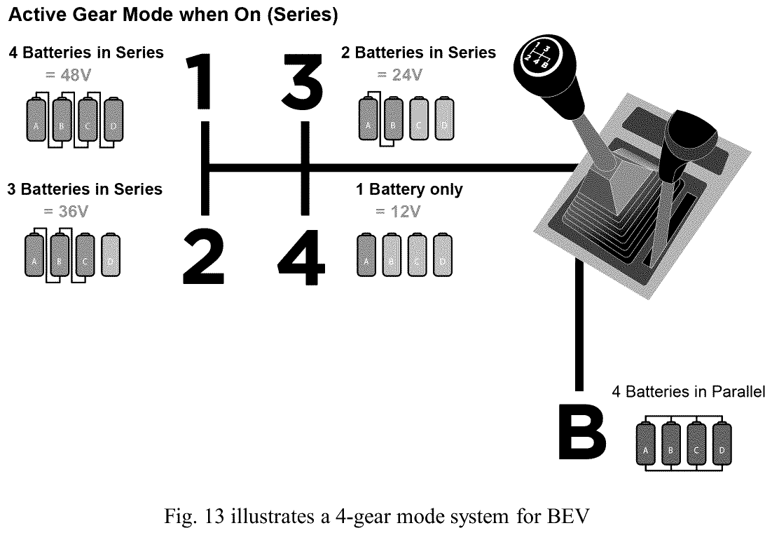

FIG. 13 depicts a typical embodiment of a smart battery switch system featuring 4 gear modes that extend the twin output voltage modes. A series-stacked 4-battery system is depicted, showcasing an exemplary embodiment that includes a switch for connecting to a power source during the rest state to charge the batteries. This embodiment features a parallel configuration that is connected to a power source, such as a DC power source or a solar photovoltaic cell during the off-mode or neutral gear. The system utilizes multiple circuits, and the switch selectively enables the parallel configuration in the off-mode for charging and transitions to the various series configuration during the on-mode for discharging at various voltage levels matching each series batteries connections in the entire battery pack without physical disconnection.

This configuration can be expanded to accommodate any number of batteries, with each grouping related to individual series-connected systems. For instance, in a 10-battery system with 12V battery, the series output voltage would be fixed at 120V, constrained by the Holmes-type switch. However, the smart battery switch with load isolation enables flexible battery connections within the 10-battery system. By using a mechanical switch, it is possible to connect 9 batteries to produce 108V, 8 batteries for 96V, and so on. Isolation for such a system can be achieved through the neutral gear system in parallel mode or by implementing a delayed timer when transitioning between the high voltage output of 120V and the low voltage of 12V, safeguarding the load from over-voltage. In this manner, it is possible to provide a battery system that can be useful for multiple load purposes instead of being limited to specific or limited purposes.

Traditional manual internal combustion engine (ICE) vehicles frequently incorporate multiple gears, often four or more. There is a compelling case for equipping battery electric vehicles (BEVs) with a similar capacity. In the context of automobiles, the initial gear typically demands higher power, equivalent to tapping into the collective power of 48V from all four batteries in a 4-battery BEV, each battery boasting a potential capacity of 12V 100Ah. This configuration ensures ample power when all four batteries are active, proving particularly useful for BEVs ascending steep inclines, while the BEV requires lower power output when only one battery is deployed, providing a 12V output. Despite potential range limitations in BEVs, this capability holds promise, especially for applications like golf carts and electric bicycles. Furthermore, with expanded battery capacity, such a feature could find applications in BEVs as well.

BEVs often spend a significant portion of their time stationary rather than in motion, presenting opportunities for recharging using renewable energy sources such as solar panels mounted on the vehicle's roof. This recharging process can take place when the battery is turned off and not in use, thereby optimizing energy efficiency. The applicability of this concept extends beyond stationary vehicles, encompassing all other non-stationary vehicles, particularly when a renewable energy power source is available, and the load is utilized intermittently. This approach can lead to reductions in battery size while maintaining sufficient power for intermittent load use cases as there are opportunities for recharging when the battery is isolated and without being physically disconnected from the load.

Furthermore, during the off mode, the battery system can be adapted for charging mode functionality by establishing a suitable connection to an external DC power source, thereby ensuring the versatile and efficient utilization of the battery system.

### Solar Watt-Peak Shifting to Battery Watt-Peak

While voltage is crucial for initiating electron movement, the actual performance of work is governed by the current. Therefore, an optimal balance between these two factors is essential to harness solar energy effectively.

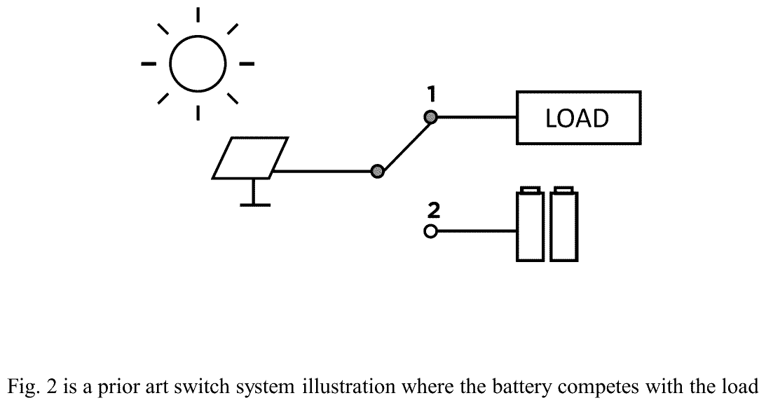

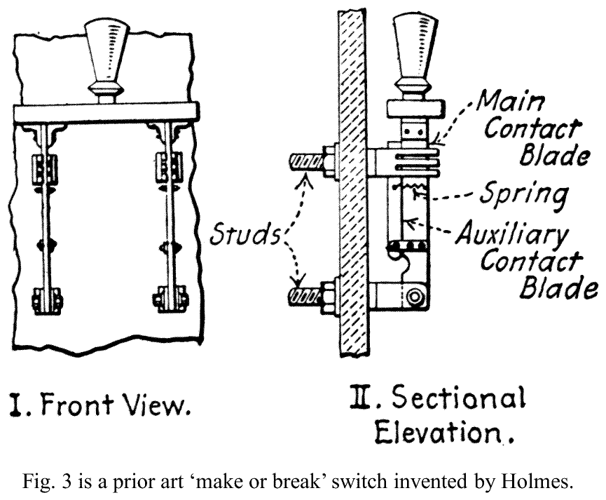

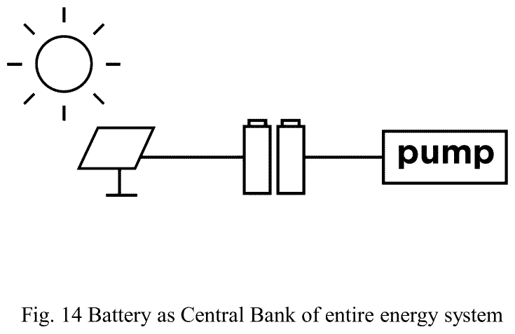

FIG. 14 depicts a battery system functioning akin to a “central bank” within the entire energy network. It efficiently receives energy from the source and distributes it to the load, mirroring the operations of an accounting system. This approach stands in contrast to the current systems illustrated in FIG. 2, where the battery is positioned in competition with the load.

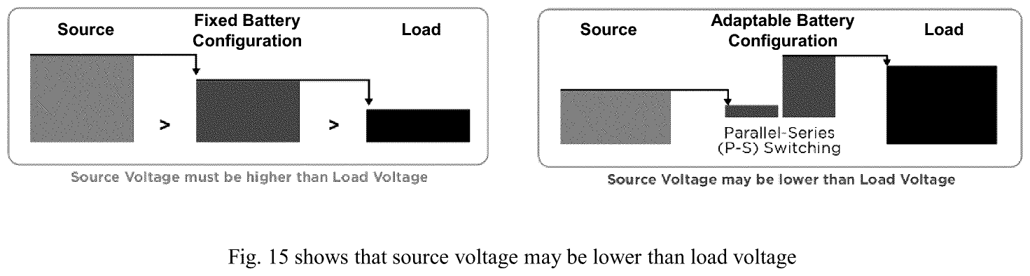

FIG. 15 illustrates the advantages of initially employing parallel charging circuits for the battery system, followed by a kinematic shift to series discharging. This method, contrasted with the current system, allows for source voltage to be lower than load voltage, thereby facilitating a shift of solar Watt-Peak (Wp) to battery Wp while uninterruptable connection is established with the solar power source. This approach could lead to the use of smaller solar panels, reducing the environmental impact associated with the disposal of larger, more extensive panels at the end of life. Moreover, as solar panels cannot be resized to match load voltages, a kinematic charging system with batteries using low voltage for charging and offering variable series output voltages using uninterrupted isolated solar source connections for discharging presents a more resource-efficient and adaptive solution for renewable energy such as solar PV systems.

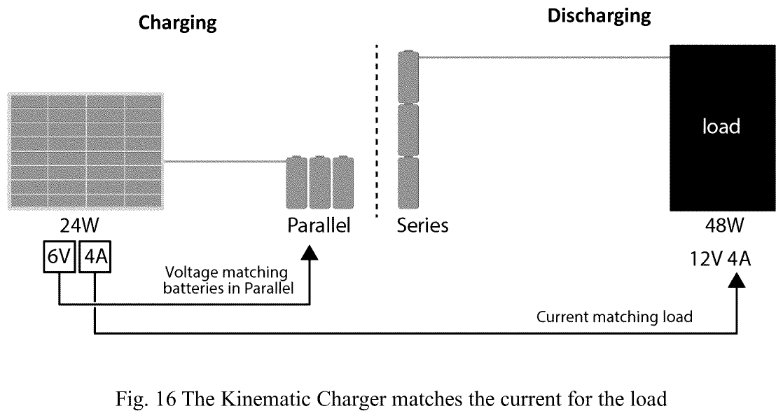

The Kinematic Charger or spatially controlled dual voltage charging system represents a significant advancement in solar PV technology, fundamentally altering how solar energy is harnessed and utilized. FIG. 16 shows that at its core, the charger addresses the primary need of electrical loads for current, which it supplies efficiently using a solar PV system operating at a reduced voltage. This innovation paves the way for more affordable solar PV solutions.

In a typical setup, the Kinematic Charger allows the battery system to switch between parallel mode for charging and series mode for discharging. This flexibility is key in maintaining efficient operation under varying conditions. The solar PV system provides the necessary current to batteries connected in parallel. When needed, a mechanism like a manual switch or a trigger transitions the batteries into series mode, meeting the higher voltage requirements of the load.

This system distinguishes itself from traditional methods, particularly in how it handles low solar irradiance. Conventional MPPT systems, designed to adjust voltage and current output from solar panels for maximum power, often reduce output or shut down during periods of low or very high irradiance to safeguard the system and batteries. This limitation arises from their tendency to shut off during low irradiance when voltage is low or during extremely high irradiance when voltage becomes too high.

In contrast, the Kinematic Charger incorporates an “internalized” MPPT algorithm that continues charging even with reduced solar input. It utilizes, for instance, 6V 2A panels to charge 4V 1A batteries (three batteries in parallel). This approach accomplishes two key objectives: Firstly, it efficiently converts excess voltage from solar irradiance into current using the MPPT algorithm. This differs from conventional systems, where the MPPT is primarily used to control the power output from the solar panels. In this new approach, the MPPT algorithm is employed to regulate the battery systems internally, effectively shifting its role from external control to an internal one where more batteries can be added in series when the irradiance is high and to charge in parallel at low irradiance. Secondly, it ensures that the batteries are always prepared for parallel charging, which is ideal for faster and safer charging. This approach promotes battery or cell balance and enables charging in off-mode when sunlight is available, enhancing the system's overall efficiency and versatility.

One key advantage of this system lies in its ability to maintain charging functionality even in suboptimal solar conditions. This capability potentially extends the effective charging duration of batteries and results in accelerated battery charging. Although it may trade peak power efficiency for prolonged operation, this trade-off proves favorable, particularly in environments with fluctuating or low-intensity sunlight by ensuring reliability using smaller battery systems, enabling the coupling of batteries with renewable energy systems making them affordable and reliable even for the bottom billion people of the world.

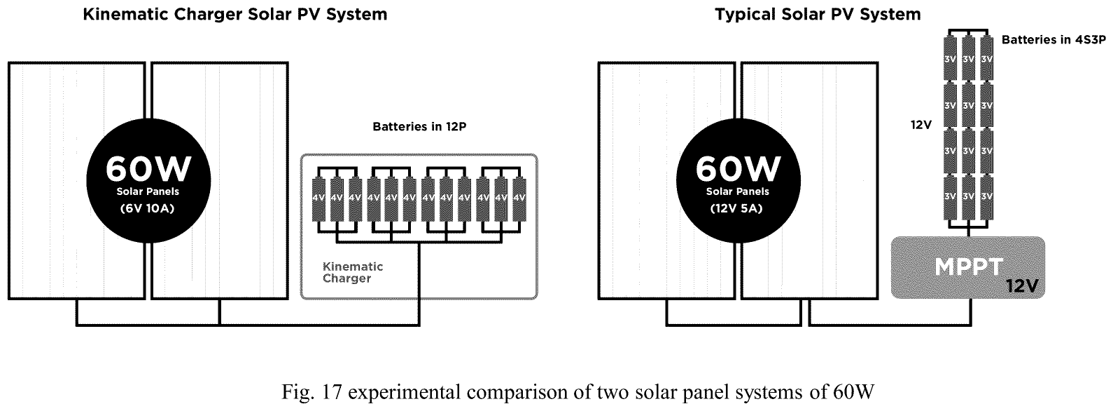

FIG. 17 illustrates an experimental comparison where both are 60 W solar panels but with different combined voltage and current. In this setup, the first set of panels is connected in parallel, generating a 6V 10A output, while the second set of panels is connected in series, generating an output of 12V 5A.

The 6V 10A parallel solar panel (first setup) demonstrates the kinematic charger's performance across various weather conditions, including rainy and overcast days when the system with MPPT or PWM solar charge controllers do not harvest energy. Under such unfavorable conditions, characterized by an irradiance level ranging from 100-200 w/m2, the kinematic charger which was capable of 12V output with 3 batteries in each charger, exhibited remarkable charging capabilities. It efficiently charged a total of 12 batteries or 4 Kinematic Chargers, each battery possessing a 4V 1Ah capacity, in parallel. The entire battery bank saw a charge increase from 3V to 4V within approximately 50 minutes. This successful outcome underscores the adaptability and efficacy of the kinematic charger under challenging weather conditions. In better conditions with irradiance levels around 500-600 w/m2, the same 12 batteries were charged in about 10 minutes by the kinematic charger. When translated into output terms where each kinematic charger is 12V 1Ah, this is the equivalent of charging 12V 6Ah batteries under moderate sunlight conditions in one hour where the solar output delivery is capable of at least 1 kW per day based on the 60 W (6V 10A) solar panel.

The series solar panel configuration (second setup) was configured to work with the 12V MPPT where the 4V batteries were arranged in 4S3P configuration meaning four sets of batteries were connected in series, while the remaining three sets were connected in parallel. The results show that it achieved 12.47V for the 4 batteries or an average of 3.1V (compared to 4V or full charge achieved by the kinematic charging system). In other words, the 12V 5A system with MPPT was not adept at charging the batteries during unfavorable low light conditions. Further, the prior art 12V MPPT required a minimum voltage and therefore functions when the solar panels are 18V instead of 12V which would require solar panels to be rated higher and therefore larger compared to the system using the kinematic charger.

Table 3 displays experimental data contrasting the performance of the parallel-series shifting space modulated kinematic charger utilizing a 60 W (6V 10A) solar panels configuration with that of an MPPT solar charge controller employing a 60 W (12V 5A) solar panels setup for the charging of 12 batteries, each having a capacity of 4V 1Ah. The readings of 100-200 W/m2 taken in Chennai, India indicate low light usually associated during rainy or cloudy conditions where the normal irradiance on a bright sunshine day is above 1,000 W/m2.

TABLE 3

| | | | Parallel Charging (6 V 10 A) | | | Series Charging (12 V 5 A) | | |
|---|---|---|---|---|---|---|---|---|
| | Time | Irradiance | Battery | Solar | Solar | Battery | Solar | Solar |
| Step | (m) | (W/m2) | Voltage(V) | Voltage(V) | Current(A) | Voltage(V) | Voltage(V) | Current(A) |
| 1 | 0 | 168 | 3 | 4.3 | 1.5 | 12 | 15.8 | 0.3 |
| 2 | 10 | 181 | 3.64 | 4.5 | 1.52 | 12.16 | 15.8 | 0.35 |
| 3 | 20 | 192 | 3.77 | 4.7 | 1.62 | 12.22 | 15.8 | 0.4 |
| 4 | 30 | 193 | 3.81 | 4.9 | 1.75 | 12.35 | 15.8 | 0.41 |
| 5 | 40 | 184 | 3.96 | 4.9 | 1.58 | 12.41 | 15.8 | 0.37 |
| 6 | 50 | 177 | 4.00 | 5 | 1.46 | 12.47 | 15.8 | 0.31 |

In summary, the kinematic charger's parallel charging and series discharging capabilities, coupled with its adaptability to varying irradiance levels, where the MPPT-type algorithm is used for internal battery charging control, rather than external solar control, enable it to outperform traditional solar panel configurations combined with MPPT devices during unfavorable conditions. This innovation significantly enhances the efficiency of solar energy harvesting and storage, positioning it as a valuable contribution to renewable energy systems.

The Kinematic Charger's innovative use of the MPPT algorithm for consistent battery charging across diverse irradiance levels marks a groundbreaking development in solar energy utilization. This approach not only enhances the practicality of solar charging systems but also broadens the application and efficiency of renewable energy sources. By redefining photovoltaic technology through efficient configurations like the parallel arrangement of solar panels, this research maximizes solar energy conversion efficiency, underscoring the critical role of current in meeting load demands.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

I claim:

1. An energy storage system, comprising
a plurality of batteries, each battery configured for energy storage,
a power source for charging the batteries,
an output load to receive power from the batteries,
an input circuit connecting power source to the batteries,
an output circuit connecting the output load to the batteries,
a switch designed to alternate between an on-mode and an off-mode,
wherein in the on-mode, the switch configures the batteries into a series-connected output circuit to discharge power to the output load, and
wherein in the off-mode, the switch configures the batteries into a parallel-connected input circuit for charging from the power source.

2. The energy storage system of claim 1, wherein the switch enables a load isolated charging system.

3. The energy storage system of claim 1, wherein in the off-mode, the switch enables cell balancing during the parallel-connected battery circuit.

4. The energy storage system of claim 1, further comprising a gear switch associated with each battery, wherein the gear switch is capable of enabling a designated voltage output during the on-mode by incrementally adding batteries in series connection, from a minimum voltage based on two batteries in series to a maximum utilizing all batteries in series.

5. The energy storage system of claim 4, wherein the plurality of batteries are configured to form a parallel-connected output circuit for generating a reduced minimum voltage, instead of complete disconnection in the off-mode.

6. An energy storage system for solar power applications, comprising
a plurality of batteries, each battery configured for energy storage,
a solar photovoltaic (PV) system for generating power to charge the batteries,
an output load to receive the power from the batteries,
an input circuit connecting the solar PV to the batteries,
an output circuit connecting the output load to the batteries,
a switch designed to alternate between an on-mode and an off-mode,
wherein in the on-mode, the switch configures the batteries into a series-connected output circuit to discharge power to the output load, and
wherein in the off-mode, the switch configures the batteries into a parallel-connected input circuit for charging from the solar PV.

7. The energy storage system of claim 6, wherein at least one solar panel having a first size wherein the output load is configured to directly receive a charge from the plurality of batteries that are charged in parallel during the off-mode using the input circuit, wherein the batteries are configured to directly receive a charge from the solar PV using an isolated load charging system, enabling reduction of the first size of the at least one solar panel by shifting solar Watt-Peak (Wp) to battery Watt-Peak (Wp) by enabling, during the on-mode, the output circuit to be reconfigured to the plurality of batteries in series while connected to the load.

8. The energy storage system of claim 7, wherein the solar PV system is capable of battery charging under varying levels of solar irradiance by converting excess voltage into current.

9. The energy storage system of claim 6, further comprising at least one solar panel having a first size wherein the first size of the at least one solar panel is capable of reduction to optimize the solar PV system and the input circuit to enable current flow after meeting the parallel voltage required by the plurality of batteries during off-mode.

10. The energy storage system of claim 6, wherein the solar PV system comprises at least one solar panel configured to optimize solar energy capture and conversion, tailored to enhance current output while maintaining an operational voltage range suitable for the connected battery system, wherein the parallel-series shifting kinematic charger is integrated with the solar PV system during the off-mode, wherein it is further configured with protection circuits designed to regulate charging voltage for preventing overcharging, ensuring the batteries operate within their safe voltage range,
wherein the kinematic charger further comprises temperature monitoring sensors for continuous assessment of the batteries' thermal conditions to prevent overheating and maintain operational safety,
wherein the configuration enhances the overall solar energy conversion efficiency of the system, effectively meeting diverse load demands while prioritizing safety and longevity of the battery system.

11. The energy storage system of claim 6 wherein at an irradiance of at least 150 W/m2 the energy storage device is capable of parallel charging at 3.64 volts applied to the battery with 4.5 volts at 1.52 amps from the at least one solar panel.

12. A battery management switch system for a battery pack comprising
a switch operable in a series mode during an on-mode for the battery pack, establishing a series connection using the plurality of batteries in series,
wherein the switch is configured to a parallel mode during an off-mode for the battery pack, establishing the plurality of batteries in parallel for cell balancing,
wherein the switch is further capable in the parallel mode of switching to a battery charging mode while uninterruptably connected to a power source.

13. The battery management switch system of claim 12, wherein the series mode is used for high-power output, and the parallel mode is used for cell balancing and charging of the batteries.

14. The battery management switch system of claim 12, wherein during the on-mode, the switch includes a multi-mode mechanism functioning similar to gear shifts, configured to adjust the voltage output of the series-connected batteries depending on the number of batteries engaged in the battery pack, thereby enabling variable voltage levels corresponding to the specific power requirements of the connected load.

15. The battery management switch system of claim 12, further comprising an electrical device system comprising an LED light direct current load, wherein the electrical device system is capable of switching between the parallel on-mode and the series on-mode to choose a desired voltage output.

16. The battery management switch system of claim 12, further comprising
operating a switch in three modes comprising the on-mode, the off-mode, and the battery charging mode,
wherein during the on-mode, the switch is configured to connect a plurality of batteries in a series arrangement,
wherein during the off-mode, the switch is reconfigured to connect the batteries in parallel, facilitating cell balancing,
wherein during the charging mode, the switch is engaged to establish a connection with an external direct current (DC) power source for battery charging, wherein the batteries remain integrated within the system while uninterruptably connected to the power source.
